(19) United States
(12) Patent Application Publication
(10) Pub. No.: US 2021/0094806 A1
(43) Pub. Date: Apr. 1, 2021

(54) High Lift System and Method

(71) Applicant: John Clemens, Deer River, MN (US)

(72) Inventor: John Clemens, Deer River, MN (US)

(21) Appl. No.: 16/588,799

(22) Filed: Sep. 30, 2019

(51) Int. Cl. B66C 23/44; B60P 1/54

(52) U.S. Cl. CPC B66C 23/44; B60P 1/5471

(57) ABSTRACT

A system and method for lifting and moving items includes a vertical post including on its lower end a horizontal extension for removably inserting into the hitch receiver receptacle of an ATV; on the opposite, upper end of the vertical post, a cantilever extends horizontally forward, away from the vehicle; pulleys are attached at each corner of the assembly; and a winch mounted on the ATV proximate the hitch receiver receptacle includes a cable that extends around each pulley and then vertically downward from a pulley at the outermost end of the cantilever portion. The end of the cable may be attached to an item to be lifted, and operation of the winch retracts the cable, lifting the item off the ground, the item then moved by repositioning the ATV.

### FIELD OF THE DISCLOSURE

The invention relates generally to an attachment for an ATV, UTV or other vehicle, and more specifically, to a system and method for lifting or moving heavy items.

### BACKGROUND

An all-terrain vehicle (ATV) typically includes a winch attached to its frame at the front end of the vehicle. Such a winch is useful for rescuing an ATV that is stuck in a particular location. The winch can be used to drag the vehicle free of its location. The winch also may be used to attach a cable to an item to be dragged from one location to another, e.g., a log, stump, boulder, etc.

In a standard configuration, however, the winch provides mainly pulling power parallel to and low to the ground. The winch provides little, if any, ability to lift an item off the ground. Thus, there remains a need for an improved, simple, and cost-effective winch system that provides an enhanced ability to lift and move items.

### SUMMARY

The present disclosure provides a system and method for lifting and moving items. The system comprises an attachment for an ATV, UTV, or the like positioned proximate an item to be lifted. A vertical post includes on its lower end a horizontal extension for removably inserting into the hitch receiver receptacle of the ATV. On the opposite, upper end of the vertical post, a cantilever extends horizontally forward, away from the vehicle. Pulleys are attached at each corner of the assembly. A winch mounted on the ATV proximate the hitch receiver includes a cable that extends around each pulley and then vertically downward from a pulley at the outermost end of the cantilever portion. The end of the cable may be attached to an item to be lifted. Operation of the winch retracts the cable, lifting the item off the ground. Then, the item may be moved by repositioning the ATV.

Other benefits and advantages of the present disclosure will be appreciated from the following detailed description.

### DESCRIPTION OF THE DRAWINGS

Exemplary embodiments of an ATV attachment for lifting items are shown in the accompanying drawings.

FIG. 1 is a perspective view of an exemplary embodiment of a lift system for use in conjunction with an ATV.

FIG. 2 is a perspective view of the lower portion of the exemplary lift system shown in FIG. 1.

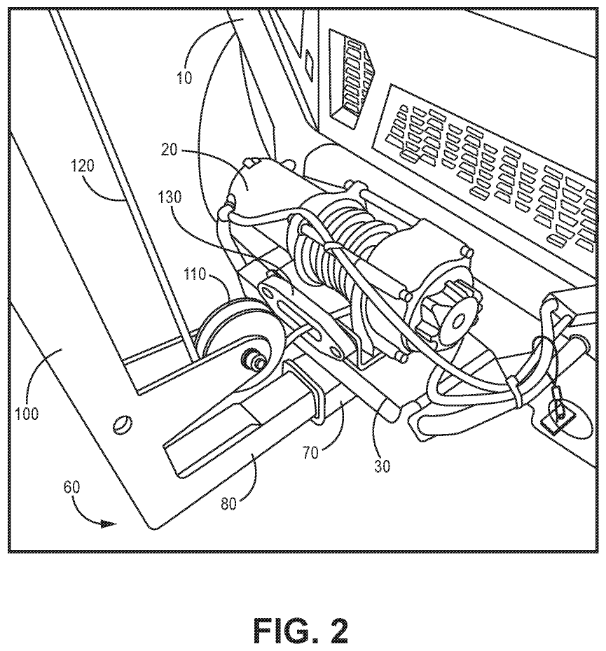

FIG. 3 is a perspective view from a side of the exemplary lift system lower portion shown in FIG. 2.

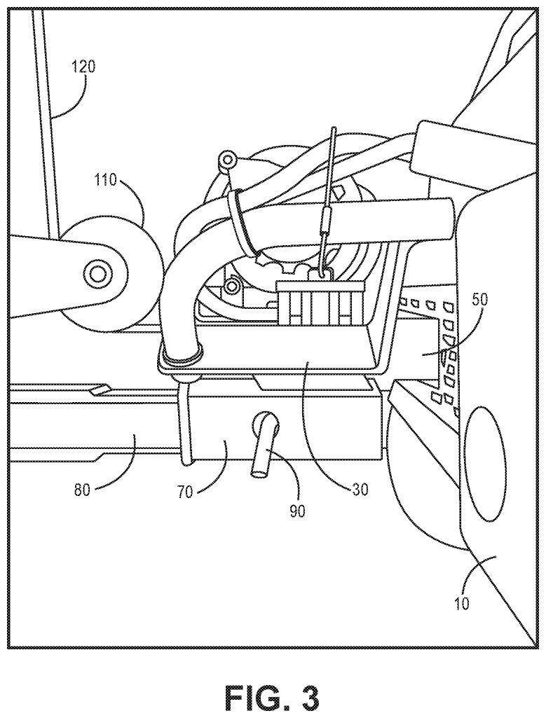

FIG. 4 is a perspective view from another side, opposite that of FIG. 3, of the exemplary lift system lower portion shown in FIG. 2.

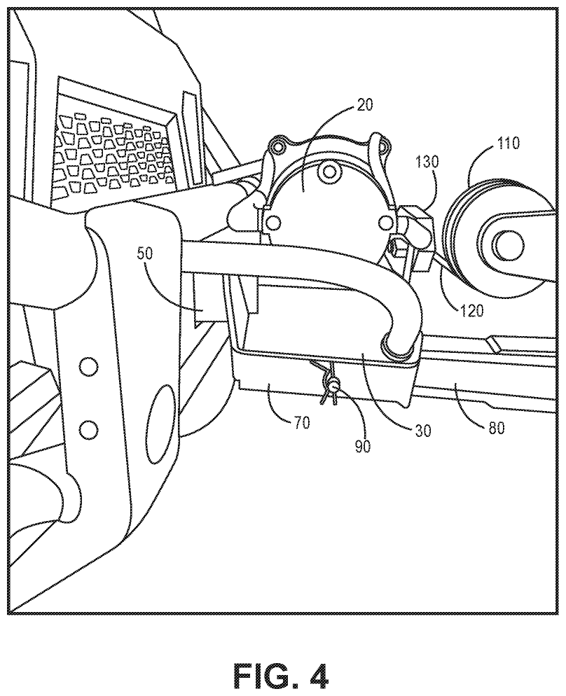

FIG. 5 is a perspective view from the top of the exemplary lift system lower portion shown in FIG. 2.

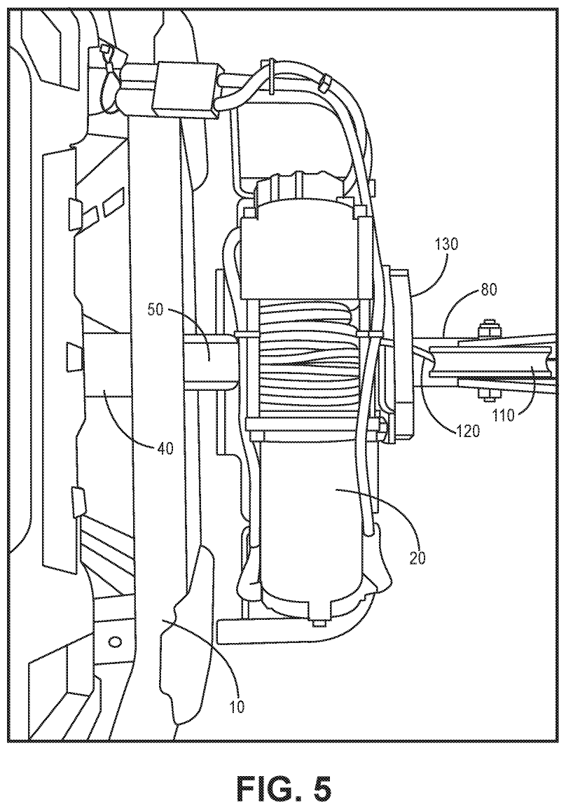

FIG. 6 is a perspective view from the bottom of the exemplary lift system lower portion shown in FIG. 2.

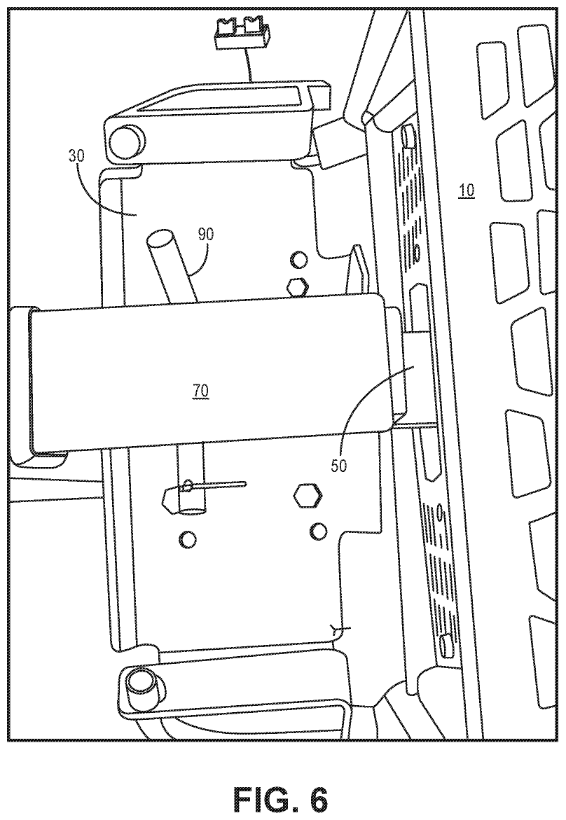

FIG. 7 is a perspective view of the uppermost portion of the exemplary lift system shown in FIG. 1.

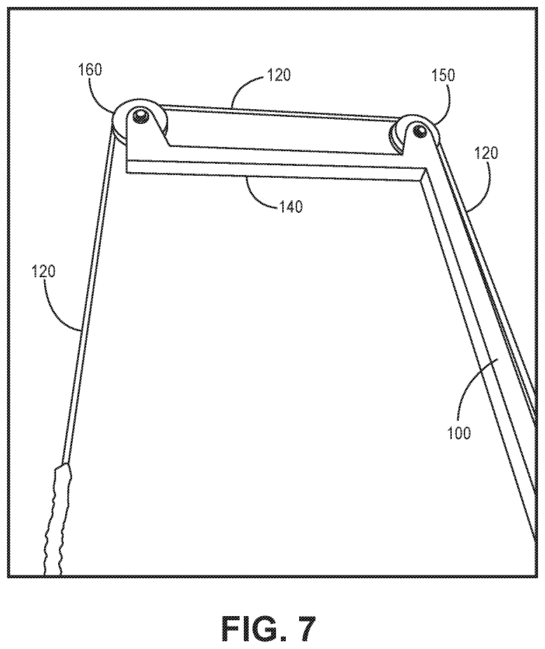

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to lifting; etc. Such aspects related to this disclosure do not depart from the invention, and it is therefore intended that the invention not be limited by the certain aspects set forth of the events and circumstances related to this disclosure.

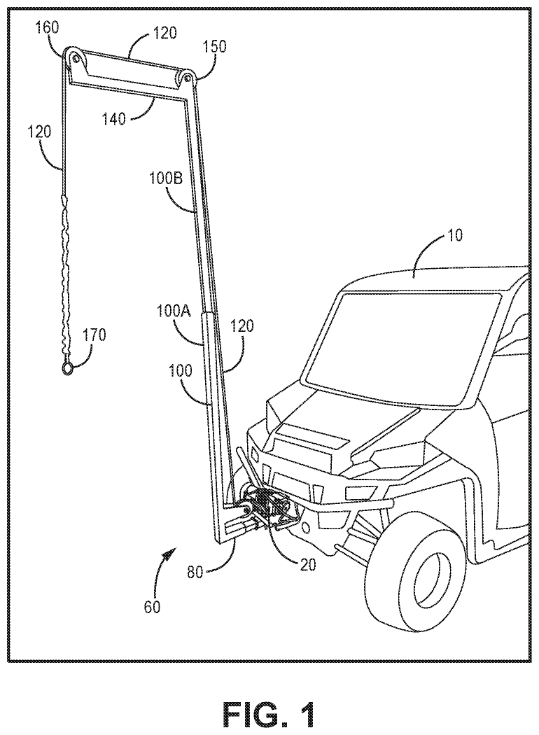

Turning now to the drawings, an exemplary system and method for lifting items is shown in FIG. 1. For convenience only, reference is made herein to an ATV. However, the system may be used with other vehicles too.

An ATV 10 includes a winch 20 mounted at its front end. The winch 20 is positioned on a plate 30 that is positioned proximate a hitch receiver receptacle 40. The hitch receiver receptacle 40 removably receives a first end 50 of the lower portion 60 of the lift assembly shown in the drawings. The first end 50 of the lower portion 60 may be removably held in the hitch receiver receptacle 40 by a pin.

First end 50 of lower portion 60 is fixedly attached to an intermediate portion 70 of lower portion 60. Intermediate portion 70 in one embodiment may extend and form a second end of lower portion 60 opposite the first end 50. In another embodiment, as shown in the drawings, intermediate portion 70 is itself adapted as a hitch receiver receptacle for receiving outermost portion 80 of the lower portion 60. A pin 90 may removably hold the outermost portion 80 within the hitch receiver receptacle portion of intermediate portion 70.

A vertical post 100 is fixedly attached to the outermost end of outermost portion 80. The lower end of vertical post 100 includes a first pulley 110 mounted proximate and in front of winch 20. In one embodiment, the first pulley 110 is positioned, or is positionable, so that a cable 120 extending between the first pulley 110 and the winch 20 is substantially horizontal. A guide 130 may be used to help control the position of the cable 120 as it comes off the winch 20 relative to the first pulley 110. In addition, the plate 30 upon which the winch 20 is positioned may be mounted to one or both of first end 50 and intermediate portion 70 to help align the cable 120 horizontally between first pulley 110 and winch 20. Thus, as shown in the drawings, intermediate portion 70 may have a longitudinal axis that is vertically offset from the longitudinal axis of first end 50

The vertical post 100 may be formed of one or more segments. See FIG. 1, which shows by way of example two segments 100A and 100B. As shown in FIG. 1, segment 100B at its lower end is removably insertable within the upper portion of segment 100A. The two segments may be connected using a pin, and may be adjustable to provide for varying heights of vertical post 100.

At the upper end of vertical post 100 a cantilever portion 140 is fixedly attached that extends forward from vertical post 100. A second pulley 150 may be provided at the outside corner formed by vertical post 100 and cantilever portion 140. The first pulley 110 and the second pulley 150 may be positioned, or may be positionable, so that a cable 120 extending between them is generally vertical.

A third pulley 160 may be positioned at the outermost end of cantilever portion 140. The third pulley 160 and the second pulley 150 may be positioned, or be positionable, so that a cable 120 extending between them is generally horizontal. Further, the third pulley 160 may be positioned, or may be positionable, so that the end 170 of cable 120 hangs vertically downward in front of the ATV 10. The end 170 of cable 120 may be adapted with a hook or other means for promoting attachment of the cable 120 to an item to be lifted.

Once the end 170 of cable 120 is attached to an item to be lifted, operation of the winch 20 will retract the cable and result in the item being lifted. Then, the ATV 10 can be repositioned to move the item to a desired location.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

What is claimed is:

1. An item-lifting attachment for an ATV including a hitch receiver receptacle, the attachment comprising:
(a) a vertical post including at an upper end of the vertical post a cantilever portion extending substantially horizontally in a first direction away from the ATV; and at a lower end of the vertical post an extension extending substantially horizontally in a second direction toward the ATV, the extension adapted so that a portion of the extension opposite the vertical post is removably insertable into the hitch receiver receptacle;
(b) a winch, including a cable, positioned proximate the hitch receiver receptacle, the winch positioned so that the cable is directed horizontally to a first pulley;
(c) the first pulley positioned at the lower end of the vertical post to receive the cable from the winch and direct the cable vertically to a second pulley;
(d) the second pulley positioned at the upper end of the vertical post to receive the cable from the first pulley and direct the cable horizontally to a third pulley; and
(e) the third pulley positioned at the end of the cantilever portion opposite the vertical post to receive the cable from the second pulley and direct the cable downward toward the item to be lifted.

2. The attachment of claim 1, wherein the first direction is opposite the second direction.

3. The attachment of claim 1, wherein the winch is mounted on a plate fixedly attached to the extension.

4. The attachment of claim 1, wherein the vertical post includes two or more separate segments that join together to form the vertical post.

5. The attachment of claim 4, wherein the segments are adjustable to vary the height of the vertical post.

6. The attachment of claim 5, wherein the segments are held together by a pin.

7. The attachment of claim 1, wherein the extension includes an intermediate portion adapted as an extension hitch receiver receptacle to receive an extension portion extending away from the lower end of the vertical post.

8. The attachment of claim 7, wherein the intermediate portion includes an outermost portion removably receivable within the ATV hitch receiver receptacle.

9. The attachment of claim 8, wherein the intermediate portion outermost portion has a longitudinal axis that is offset from a longitudinal axis of the extension portion extending substantially horizontally from the vertical post.

10. The attachment of claim 9, wherein the winch is removably coupled to a plate fixedly attached to the intermediate portion.
